(19) United States
(12) Patent Application Publication
(10) Pub. No.: US 2024/0329251 A1
(43) Pub. Date: Oct. 3, 2024

(54) LiDar-Based Perception Method for Small Traffic Equipment And Apparatus of the Same

(71) Applicants: Hyundai Motor Company, Seoul (KR); Kia Corporation, Seoul (KR)

(72) Inventors: Ju Hyeok RA, Guri-si (KR); Hyun Ju KIM, Yongin-si (KR)

(21) Appl. No.: 18/524,064

(22) Filed: Nov. 30, 2023

(30) Foreign Application Priority Data
Mar. 27, 2023 (KR) 10-2023-0039703

(51) Int. Cl. G01S 17/88; G01S 7/4865; G06V 20/58

(52) U.S. Cl. CPC G01S 17/88; G01S 7/4865; G06V 20/58

(57) ABSTRACT

A method for recognizing small-traffic-equipment based on a LiDAR may include determining by acquiring LiDAR data of a surrounding environment and determining objects through data processing, selecting candidate objects of a size equal to or smaller than a predetermined size among the objects, determining at least one object cluster by grouping the candidate objects according to a predetermined position condition, and outputting information on at least one first cluster from the at least one object cluster.

### CROSS-REFERENCE TO RELATED APPLICATION

The present application claims priority to Korean Patent Application No. 10-2023-0039703, filed on Mar. 27, 2023, the entire contents of which is incorporated herein by reference in its entirety.

### TECHNICAL FIELD

The present disclosure relates to a LiDAR-based perception method for small traffic equipment and apparatus of the same.

### BACKGROUND

When perceiving an object using LiDAR, numerous objects may be perceived according to clustering and shape analysis of points, and identification of a significant object may be required.

Small traffic equipment such as delineator posts, road cones, and PE-drum are often not output due to their size priority even when they are positioned close to the host vehicle.

Therefore, accurate perception of small traffic equipment and output thereof are required in spite of size priority.

### SUMMARY

Systems, apparatuses, methods, and computer-readable media are described for LiDAR-based object perception. The LiDAR-based object perception may include determining objects by acquiring LiDAR data of a surrounding environment through data processing, selecting, from the objects, candidate objects having a size equal to or smaller than a predetermined size, determining at least one object cluster by grouping the candidate objects according to a predetermined position condition, and outputting information about at least one first cluster from the at least one object cluster.

These and other features and advantages are described below in greater detail.

### BRIEF DESCRIPTION OF DRAWINGS

FIG. 1 shows an object recognition device according to one or more aspects of the present disclosure.

FIG. 2 show examples of small traffic equipment such as a delineator post, a road cone, a PE-drum, etc.

FIG. 3 illustrates a method of recognizing an object according to one or more aspects of the present disclosure.

FIG. 4 is an example of a candidate object among objects detected by the LiDAR.

FIG. 5 illustrates a clustering condition for clustering candidate objects.

FIG. 6 illustrates a candidate object cluster.

FIG. 7 is a flowchart illustrating an example of tracking a small-traffic-equipment clustering region.

FIG. 8 illustrates a result of object recognition according to a comparative example of the present disclosure.

### DETAILED DESCRIPTION

Since the present disclosure may be modified in various ways and have various configurations, specific examples will be illustrated and described with reference to the drawings. However, this is not intended to limit the present disclosure to the specific examples, and it should be understood that the present disclosure includes all modifications, equivalents, and replacements included within the concept and the technical scope of the present disclosure.

The suffixes “module” and “unit” used in the present specification are used solo for name differentiation between elements, and should not be construed as presupposing that they are physically or chemically divided or separated or otherwise.

Terms including an ordinal number such as “first”, “second”, etc. are used to describe various elements, but the elements are not limited by the terms. The terms are used only for the purpose of distinguishing one component from another element.

The term “and/or” may be used to include any combination of a plurality of items to be included. For example, “A and/or B” includes all three cases such as “A”, “B”, and “A and B”.

When it is mentioned that an element is “connected” or “connected” to another element, the element is directly connected or connected to the other element, but it should be understood that another element exist in between.

The terminology used herein is for the purpose of describing particular aspects only and is not intended to be limiting of the present disclosure. A singular expression includes a plural expression unless the context clearly indicates otherwise. In the present application, it should be understood that the term “include” or “have” indicates that a feature, a number, a step, an operation, a component, a part, or a combination thereof described in the specification is present, but does not exclude the possibility of existence or addition of one or more other features, numbers, steps, operations, components, parts, or combinations thereof in advance.

In addition, the unit or the control unit may be a term widely used for naming a controller for controlling a vehicle specific function, and does not mean a generic function unit. For example, each unit or the control unit may include, e.g., a communication device communicating with another controller or a sensor to control a function in charge, a memory storing an operating system or a logic command, input/output information, and the like, and one or more processors performing determination, operation, judgement, and the like necessary for controlling a function in charge.

The processor may include a semiconductor integrated circuit and/or an electronic devices that perform at least one or more of comparison, determination, calculation, and determination to achieve a programmed function. For example, the processor may be a computer, a microprocessor, a CPU, an ASIC, and a circuitry (logic circuits), or a combination thereof.

In addition, the computer-readable recording medium includes all types of storage devices in which data that can be read by a computer system is stored. For example, the memory may include at least a flash memory, a hard disk, a micro type, a card (i.e., a Secure Digital (SD) card or an eXtream Digital (XD) card), etc., and a Random Access Memory (RAM), a Static RAM (SRAM), a Read-Only Memory (ROM), a Programmable ROM (PROM), an Electrically Erasable PROM (EEPROM), a Magnetic RAM (MRAM), a magnetic disk, and an optical disk.

The recording medium may be electrically connected to the processor, and the processor may retrieve and record data from the recording medium. The recording medium and the processor may be integrated or may be physically separated.

The accompanying drawings will be briefly described, and aspects of the present disclosure will be described in detail with the accompanying drawings.

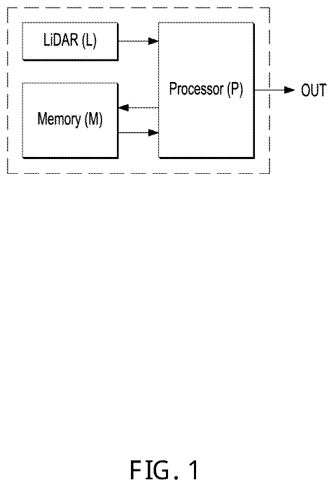

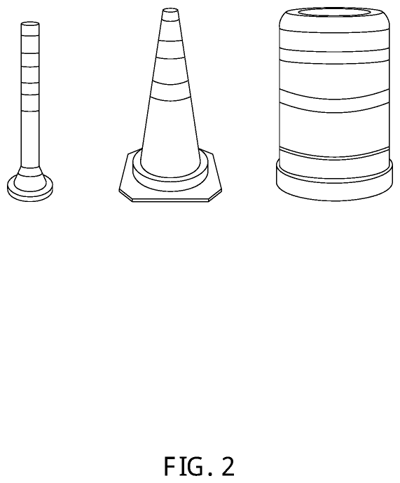

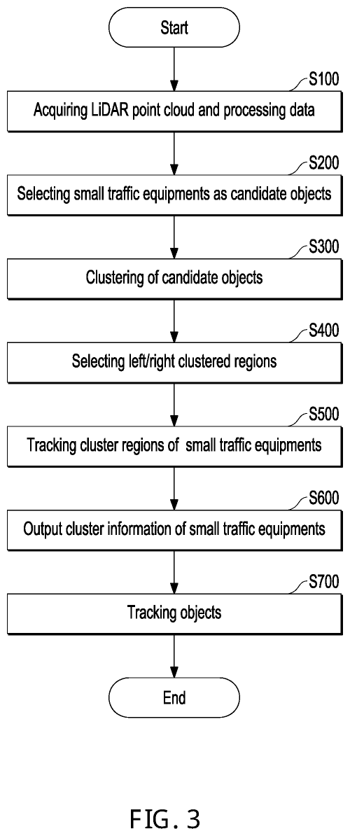

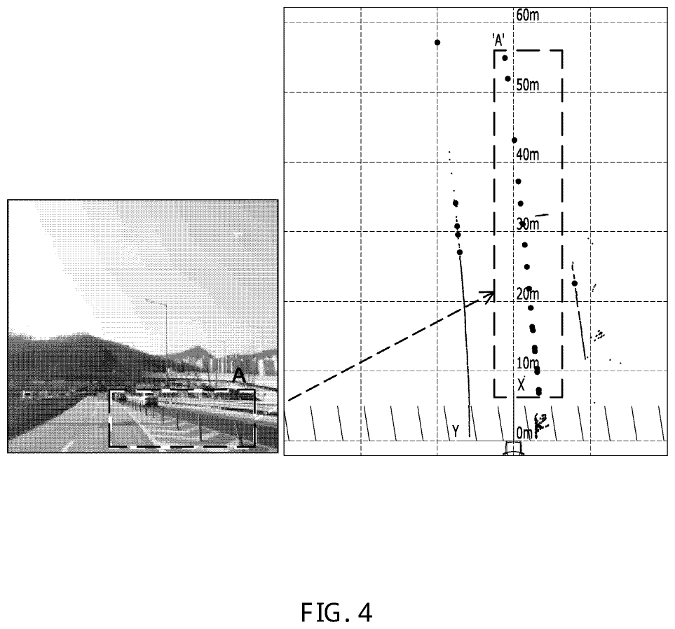

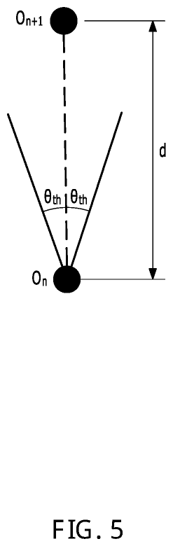

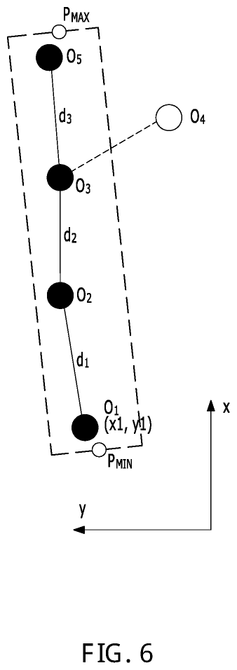

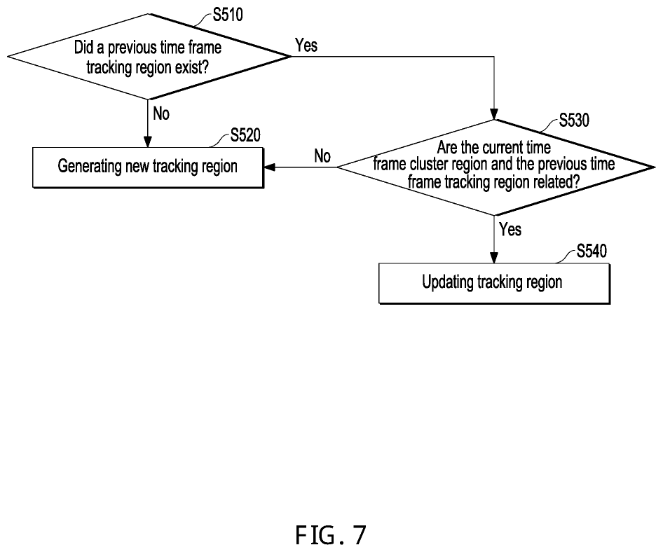

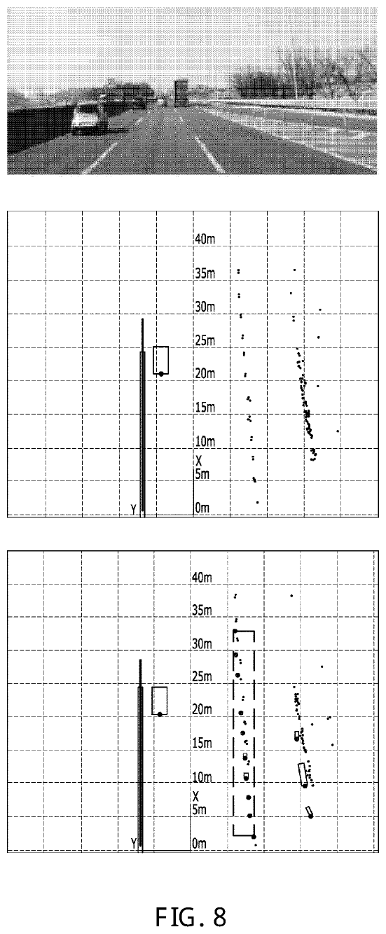

FIG. 1 shows an object recognition device according to one or more aspects of the present disclosure, and FIG. 2 shows an example of small traffic equipment such as delineator posts, road cones, PE-drums, and the like. FIG. 3 illustrates an object recognition method according to one or more aspects of the present disclosure, and FIG. 4 illustrates an example of a candidate object among objects detected by LiDAR. FIG. 5 illustrates a clustering condition for clustering candidate objects, and FIG. 6 illustrates a candidate object clustering. FIG. 7 is a flowchart illustrating an example of tracking a small-traffic-equipment clustering region, and FIG. 8 illustrates object recognition results according to a comparative example of the present disclosure.

As shown in FIG. 1, the LiDAR-based object recognition apparatus according to one or more aspects of the present disclosure may include at least one LiDAR sensor, a memory, and a processor.

The memory stores various data and a computer program necessary for implementing the object recognition method.

The processor performs the object recognition method by reading and executing the program from the memory.

The flowchart illustrated in the processor of FIG. 3 represents a method of recognizing objects and will be described in detail below.

Initially in S100, surrounding environment data (hereinafter referred to as “LiDAR data”) is obtained through a LiDAR sensor.

The LiDAR sensor emits a single circular laser pulse with a wavelength of 905 nm to 1550 nm to an object, and then measure a time for which the laser pulse reflected from the object within the measurement range, thereby sensing information about the object, such as a distance from the LiDAR sensor to the object, a direction, a speed, a temperature, a material distribution, and a concentration characteristic of the object.

The LiDAR sensor includes a transmitter (not shown) for transmitting a laser pulse and a receiver (not shown) for receiving a laser reflecting from the surface of an object that is within a sensor range and returned.

The LiDAR sensor has a Field Of View (FOV), which is an observable region. The viewing angles can be categorized into a horizontal viewing angle and a vertical viewing angle.

Since the LiDAR sensor has a higher detection accuracy for the longitudinal/transverse direction than the radar, the LiDAR sensor can provide accurate longitudinal/transverse position information, and thus it can be easily used for obstacle detection, vehicle position recognition, etc.

Examples of the LiDAR sensor include a two-dimensional (2D) LiDAR sensor and a three-dimensional (3D) LiDAR sensor. The 2D LiDAR sensor is configured to tilted or to rotate, and is used to secure LiDAR data including 3D information by being tilted or rotated. The 3D LiDAR sensor can obtain a plurality of points in the third dimension, and can predict the height information of an obstacle, thereby helping accurate and detailed object detection or tracking.

The 3D LiDAR sensor can be implemented by configuring one channel with a plurality of 2D LiDAR sensors in a vertical direction. The 3D LiDAR sensor configured as described above can be provided with 16 or 32 channels in a vertical direction as an example. The LiDAR data of the plurality of channels acquired as described above can be projected onto a predetermined number of layers (less than the number of channels) and converted into multi-layer data.

The LiDAR sensor outputs point cloud data, and the point cloud data can be acquired for each time frame at a predetermined time interval.

The LiDAR data can be processed through data processing such as pre-processing, clustering, and object detection.

The preprocessing can perform calibration for matching coordinates between the LiDAR sensor and the vehicle where the LiDAR sensor is mounted. In other words, the LiDAR sensor can convert the LiDAR data apt for the reference coordinate system depending on the positioning angle where the LiDAR sensor is mounted on the vehicle. In addition, the issue of low intensity or low reflection can be removed through filtering based on the information of intensity or confidence of the LiDAR data.

In addition, data in reflection of the vehicle body of the host vehicle are removed through preprocessing. In other words, since there is an area covered by the vehicle body of the vehicle itself according to a mounting position and a viewing angle of the LiDAR sensor, data in reflection of the vehicle body of the vehicle itself are removed using the reference coordinate system.

After pre-processing, points of the LiDAR data are grouped into a plurality of clusters through a clustering process with a clustering algorithm.

For each point cluster, a square-shaped cluster box including points of the corresponding cluster can be defined.

These clusters are candidates of objects to be detected, and the shape of the corresponding object is analyzed through an object detection process.

For example, the main points are extracted from points that are included in a cluster, and the outer points are determined among the main points by using a “convex hull” algorithm.

Lines connecting the outer points form a contour of the corresponding object. Also, square-shaped boxes surrounding the outer points that are shortest in sum of distances from outer points to side shortest in distance, i.e., bounding boxes, are in other words defined as bounding boxes, in which a sum of distances from outer points to a side of the shortest distance is the smallest, among square boxes surrounding the outer points can be defined.

In short, shape information (i.e., an outer point, a contour, a bounding box, etc.) for each object is acquired through the above-described data processing for the LiDAR data.

Detecting an object from the LiDAR data as described above is already known, so further detailed description thereof will be omitted.

After the objects are detected in S200, candidate objects corresponding to the small traffic equipment are determined.

FIG. 2 illustrates a delineator post, a road cone, and a PE-drum as examples of small traffic equipment.

The height of the delineator posts for urban area are 0.4 m, the ones for highways are 0.7 m, and the height for road cones for highways are 0.75 m, and the height of the PE-drums are 0.8 m that are for urban use.

In addition, the width (i.e., the transverse length) and the length (i.e., the longitudinal length) of the delineator posts, the road cones, the PE-drums, and the like are all 1 m or less.

Accordingly, if the candidate object is determined in S200, the size of the corresponding object is considered.

For example, objects having a transverse length and/or a longitudinal length of 1 m or less are determined as candidate objects.

FIG. 4 illustrates an example in which a delineator post is selected as a candidate object among objects detected by the LiDAR. The left side of FIG. 4 shows a camera image of a corresponding scene, and the right side shows a Bird Eyed View (BEV) image of objects detected using a LiDAR sensor for the corresponding scene. As shown in FIG. 4, delineator posts (part A) of the left image are detected as candidate objects (A′ part).

After determining the optional objects in S300, the candidate objects are clustered.

To this end, a condition of set position for the center points (e.g., the center points of the cluster box or the bounding box of the corresponding object) of each candidate object is applied for grouping.

The condition of set position includes conditions of a distance and an angle.

For example as shown in FIG. 5, objects in which a distance d between the candidate objects On and On+1 is within a predetermined distance and a predetermined angles for both left and right side is within the predetermined angle are clustered into the same group.

In the case of a straight road bifurcating or entering the straight road at a point when finishing the ramp section, there may be the delineator post, and even though the cases of small traffic equipment at construction sites have shapes that block one lane diagonally in most of the straight roads, the radii of curvatures are usually 200 m or more, in the case of straight or gently curved roads other than the ramp sections.

According to the Road Safety Facility Installation Regulations, all delineator post are arranged in intervals of 10 m or less.

Considering this point as an example, the predetermined distance may be within 10 m, and the predetermined angle may be 11.5 degrees.

Preferably, the predetermined distance and the predetermined angle are tuned to an optimal value through an experiment.

The grouping for object clustering starts from the candidate object closest to the own vehicle and are performed until a search for all candidate objects is completed.

FIG. 6 illustrates objects grouped into one cluster.

In FIG. 6, a first object O₁, a second object O₂, a third object O₃, and a fifth object O₅ are grouped into one cluster SOCL, and a fourth object O₄ is excluded because it does not satisfy a condition of position, particularly in the condition of angle.

If the clustering of the objects is completed, the at least one candidate cluster of the small traffic equipment is determined according to the cluster condition set in S400, and the closest object cluster to the left side and the right side of the host vehicle is selected therefrom.

Here, the cluster condition includes the quantity of candidate objects belonging to the object cluster includes at least the first condition in which the first predetermined value or greater or equal to the quantity of candidate objects belonging to the object cluster, a second condition in which a second predetermined value greater or equal to the sum of distance between candidate objects, the third condition in which an average distance between the candidate objects is equal to or less than the third predetermined value, or the fourth condition in which a longitudinal distance from the host vehicle to the at least one candidate cluster is equal to or less than the fourth predetermined value.

For example, assuming that the first predetermined value is 4, the object cluster SOCL of FIG. 6 satisfies the first condition.

Illustratively, the second predetermined value and the third predetermined value are 10 m, and in the case of the cluster of FIG. 6, if the distance sum “d1+d2+d3” is equal to or greater than 10 m, the second condition is satisfied, and if the average distance “(d1+d2+d3)/3” is equal to or less than 10 m, the third condition is also satisfied.

The longitudinal distance from the host vehicle of the corresponding cluster from FIG. 6 is “x1”, and if the longitudinal distance is equal to or less than the fourth predetermined value, the fourth condition is satisfied.

If the at least one candidate cluster is determined and the small-traffic-equipment cluster closest to the left and/or the right is determined, a cluster region thereof is determined, and tracking of the corresponding region is performed in S500. The cluster region determined at every frame is managed through tracking, and thoroughly a stable recognition results for the small-traffic-equipment cluster are acquired.

Here, the cluster region SOCL as shown in FIG. 6 has a square-shaped box of minimum size including objects of a corresponding cluster. If the cluster region is determined, a minimum point PMIN and a maximum point PMAX indicating the corresponding region are determined. Here, the minimum point (PMIN) is denoted as a center point of one of four sides of the corresponding square box, which is closest to the host vehicle in the longitudinal direction, and the maximum point (PMAX) are defined as a center point of the opposite side.

FIG. 7 is a flowchart of an example of the tracking process, which will be described in detail.

Firstly, S510 determines whether a tracking region of a previous time frame, i.e., an existing tracking region, exists.

As a result of the determination, if the existing tracking region does not exist, a new tracking region is generated based on the cluster region determined during a current time frame in S520.

Contrastingly, if there is an existing tracking region, the correlation between the existing tracking region and the clustered region of the current time frame is determined in S300.

In order to determine the correlation, the predicted region is determined from the existing tracking region to the current time frame.

Since the position and the attitude of the host vehicle are changed during the elapsed time Δt between the previous time frame and the current time frame, the region in the current time frame of the existing tracking region are predicted in consideration of such a change, and the predicted region can be determined.

The position change of the host vehicle is a moving distance during the elapsed time Δt, and the longitudinal (i.e., x-axis) and transverse (i.e., y-axis) movement distances are acquired through the following equations.

$$\begin{matrix}{x}_{dist} = {V}_{x} \times Δ t \\ {y}_{dist} = {V}_{y} \times Δ t\end{matrix} \qquad [ Equation 1 ]$$

Here, x_{dist} denotes a longitudinal moving distance, y_{dist} denotes a transverse moving distance, Vₓ denotes a longitudinal velocity, and V_{y} denotes a transverse velocity.

The position change of the host vehicle, i.e., the yaw rate variance θ, is acquired by multiplying the elapsed time Δt and the yaw rate.

The predicted regions are acquired through coordinate transformation and rotational transformation as shown in the following equation with respect to shape coordinate values (x, y) of the existing tracking region.

$$\begin{matrix}[ \begin{matrix}{x}^{′} \\ {y}^{′}\end{matrix} ] = [ \begin{matrix}x + {x}_{dist} \\ y + {y}_{dist}\end{matrix} ] \\ [ \begin{matrix}{x}^{″} \\ {y}^{″}\end{matrix} ] = [ \begin{matrix}{x}^{′} cos θ & {y}^{′} sin θ \\ {x}^{′} sin θ & {y}^{′} cos θ\end{matrix} ]\end{matrix} \qquad [ Equation 2 ]$$

Here, x″ and y″ indicate shape coordinate values of the predicted region.

If the predicted region is determined, the correlation with the corresponding cluster region determined in the current time frame is determined, and the correlation is determined by considering the distance between the two regions.

For example, if the predicted region and the cluster region of the current time frame exist within one lane, it will be determined that the two regions are associated with each other.

If the correlation is recognized in S540, the cluster region of the current time frame is corrected based on the predicted region, and the tracking region is updated to continuously maintain the tracking.

If there is no correlation such as when there is no existing tracking region for the cluster region determined in the current time frame, a new tracking region for the cluster region is generated in S520.

Referring back to FIG. 3 after S500 is completed, S600 outputs an information about the corresponding small-traffic-equipment cluster (the first cluster).

If the information is output, flags are given as output indicating small traffic equipment are given to objects belonging to the small-traffic-equipment cluster.

Therefore, objects detected from the LiDAR data among the output objects, objects corresponding to small traffic equipment are given flags as output indicating that the objects are small traffic equipment.

The detected objects are tracked and managed in S700, which will be described in detail.

The number of objects detected by LiDAR in one time frame may be more than a hundred.

Due to the limitations of the memory and the processor, all objects by the hundreds cannot be managed, and only a predetermined number of objects are tracked and managed.

The selection of the tracking target among the detected objects is performed according to a predetermined rule of priority order.

For example, the rule of priority order includes a rule that excludes a small object whose age is equal to or less than a predetermined value based on the time frame from the tracking target.

However in this case, the small traffic equipment that is given the flag for small-sized objects can be predetermined to not apply the exclusion rule.

Thus, the present examples can respond to small traffic equipment adjacent to the host vehicle.

FIG. 8 illustrates the object recognition results of comparative examples for the same scene.

In FIG. 8, an upper image represents a camera image of a corresponding scene, a middle image represents an object recognition result of a comparative example, and a lower image represents an object recognition result of an aspect.

Although the existing camera image of the delineator post from the right are not properly output as the recognition result from the comparative example, it can be known that they are output.

The method and apparatus of the above-described configurations and/or examples may be used for autonomous driving of level 3 or higher.

Provided are a method and an apparatus for accurately perceiving small traffic equipment and outputting the small traffic equipment as an object in object perception based on LiDAR.

A method for recognizing small traffic equipment based on a LiDAR may comprise determining by acquiring LiDAR data of a surrounding environment and determining objects through data processing, selecting candidate objects of a size equal to or smaller than a predetermined size among the objects, determining at least one object cluster by grouping the candidate objects according to a predetermined position condition, and outputting information on at least one first cluster from the at least one object cluster.

In at least one or more aspects of the present disclosure, the predetermined size includes a longitudinal size and a transverse size.

The predetermined position condition may include a distance condition and an angle range condition between the candidate objects.

The method may further comprise determining at least one candidate cluster of the at least one object cluster according to a predetermined cluster condition and determining at least one small-traffic-equipment cluster from the at least one candidate cluster as the first cluster.

The predetermined cluster condition may include at least one of a first condition that a number of the candidate objects included in the at least one object cluster is equal to or greater than a first predetermined value, a second condition that a sum of distances between the candidate objects is equal to or greater than a second predetermined value, a third condition that an average distance between the candidate objects is equal to or less than a third predetermined value, and a fourth condition that a longitudinal distance from a host vehicle to the at least one candidate cluster is equal to or less than a fourth predetermined value.

Determining the at least one first cluster may comprise determining at least one closest candidate cluster closest to a left side and/or a right side of the host vehicle among the at least one candidate cluster, and determining the at least one small-traffic-equipment cluster among the at least one closest candidate cluster.

The method may further comprise generating a new tracking region for the at least one first cluster or updating a tracking region according to a correlation between a region of a current time frame of the at least one first cluster and the tracking region of a previous time frame.

The correlation may be determined based on a predicted region in the current time frame which is predicted from the tracking region of the previous time frame.

Outputting the information may comprise assigning flags indicating small-traffic-equipment to objects belonging to the at least one first cluster.

The method may further comprise determining and tracking a predetermined number of objects according to a predetermined priority order, wherein small objects having a time-frame-based age of a predetermined value or less are excluded from the tracking except for the objects to which the flags of small-traffic-equipment are assigned.

According to another aspect of the present disclosure, there may be provided a LiDAR-based small-traffic-equipment recognition apparatus comprising a LiDAR sensor to acquire LiDAR data of a surrounding environment, a computer-readable recording medium in which a computer program of LiDAR-based object perception is stored, and a processor for executing the computer program, wherein the processor is configured to perform by executing the program determining objects through data processing from the LiDAR data through an execution of the computer program, selecting candidate objects having a size equal to or smaller than a predetermined size among the objects, determining at least one object cluster by grouping the candidate objects according to a predetermined position condition, and outputting information on at least one first cluster among the at least one object cluster.

The predetermined size may include a longitudinal size and a transverse size.

The predetermined position condition may include a distance condition and an angle range condition between the candidate objects.

The processor may be further configured to perform determining at least one candidate cluster among the at least one object cluster according to a predetermined cluster condition, and determining at least one small-traffic-equipment cluster as the first cluster from the at least one candidate clusters.

The predetermined cluster condition may include at least one of a first condition that a number of the candidate objects included in the at least one object cluster is equal to or greater than a first predetermined value, a second condition that a sum of distances between the candidate objects is equal to or greater than a second predetermined value, a third condition that an average distance between the candidate objects is equal to or less than a third predetermined value, and a fourth condition that a longitudinal distance from a host vehicle to the at least one candidate cluster is equal to or less than a fourth predetermined value.

Determining the at least one first cluster may comprise determining at least one closest candidate cluster closest to a left side and/or a right side of the host vehicle from the at least one candidate cluster and determining the at least one small-traffic-equipment cluster among the at least one closest candidate cluster.

The processor may be further configured to perform generating a new tracking regions for the at least one first cluster or updating a tracking region according to a correlation between a region of a current time frame of the at least one first cluster and the tracking region of a previous time frame.

The correlation may be determined based on a predicted region in the current time frame which is predicted from the tracking region of the previous time frame.

Outputting the information may comprise assigning flags indicating small-traffic-equipment to objects belonging to the at least one first cluster.

The processor may be further configured to perform determining and tracking a predetermined number of objects according to a predetermined priority order, wherein small objects having a time-frame-based age of a predetermined value or less are excluded from the tracking except for the objects to which the flags of small-traffic-equipment are assigned.

The perception performance for small-traffic-equipments may be improved and small-traffic-equipments may respond while the quantity of perceived objects is limited.

What is claimed is:

1. A LIDAR-based object perception method comprising:
determining objects by acquiring LiDAR data of a surrounding environment through data processing;
selecting, from the objects, candidate objects having a size equal to or smaller than a predetermined size;
determining at least one object cluster by grouping the candidate objects according to a predetermined position condition; and
outputting information about at least one first cluster from the at least one object cluster.

2. The method of claim 1, wherein the predetermined size comprises a longitudinal size and a transverse size.

3. The method of claim 1, wherein the predetermined position condition comprises a distance condition and an angle range condition between the candidate objects.

4. The method of claim 1, further comprising:
determining at least one candidate cluster of the at least one object cluster according to a predetermined cluster condition; and
determining, from the at least one candidate cluster and as the at least one first cluster, at least one small-traffic-equipment cluster.

5. The method of claim 4, wherein the predetermined cluster condition comprises at least one of a first condition such that a quantity of the candidate objects in the at least one object cluster is equal to or greater than a first predetermined value, a second condition such that a sum of distances between the candidate objects is equal to or greater than a second predetermined value, a third condition such that an average distance between the candidate objects is equal to or less than a third predetermined value, and a fourth condition such that a longitudinal distance from a host vehicle to the at least one candidate cluster is equal to or less than a fourth predetermined value.

6. The method of claim 4, wherein determining the at least one first cluster comprises determining at least one closest candidate cluster closest to a left side or a right side of a host vehicle among the at least one candidate cluster, and determining the at least one small-traffic-equipment cluster among the at least one closest candidate cluster.

7. The method of claim 1, further comprising generating a new tracking region for the at least one first cluster or updating a tracking region of a previous time frame based on a correlation between a region of a current time frame of the at least one first cluster and the tracking region of the previous time frame.

8. The method according to claim 7, wherein the correlation is determined based on a predicted region in the current time frame which is predicted from the tracking region of the previous time frame.

9. The method of claim 1, wherein outputting the information comprises assigning flags indicating small-traffic-equipment to objects belonging to the at least one first cluster.

10. The method of claim 9, further comprising determining and tracking a predetermined number of objects according to a predetermined priority order, wherein small objects having a time-frame-based age of a predetermined value or less are excluded from the tracking except for the objects to which the flags indicating the small-traffic-equipment are assigned.

11. A LIDAR-based object perception apparatus comprising:
a LiDAR sensor to acquire LiDAR data of a surrounding environment;
one or more processors; and
a computer-readable recording medium storing instructions that, when executed by the one or more processors, cause the LiDAR-based object perception apparatus to:
determine objects through data processing of the LiDAR data;
select candidate objects having a size equal to or smaller than a predetermined size among the objects;
determine at least one object cluster by grouping the candidate objects according to a predetermined position condition; and
output information on at least one first cluster among the at least one object cluster.

12. The apparatus of claim 11, wherein the predetermined size comprises a longitudinal size and a transverse size.

13. The apparatus of claim 11, wherein the predetermined position condition comprises a distance condition and an angle range condition between the candidate objects.

14. The apparatus of claim 11, wherein the instructions, when executed by the one or more processors further cause the LiDAR-based object perception apparatus to:
determine at least one candidate cluster among the at least one object cluster according to a predetermined cluster condition; and
determine, from the at least one candidate cluster and as the at least one first cluster, at least one small-traffic-equipment cluster.

15. The apparatus of claim 14, wherein the predetermined cluster condition comprises at least one of a first condition such that a quantity of the candidate objects included in the at least one object cluster is equal to or greater than a first predetermined value, a second condition such that a sum of distances between the candidate objects is equal to or greater than a second predetermined value, a third condition such that an average distance between the candidate objects is equal to or less than a third predetermined value, and a fourth condition such that a longitudinal distance from a host vehicle to the at least one candidate cluster is equal to or less than a fourth predetermined value.

16. The apparatus of claim 14, wherein determining the at least one first cluster comprises determining at least one closest candidate cluster closest to a left side or a right side of a host vehicle from the at least one candidate cluster and determining the at least one small-traffic-equipment cluster among the at least one closest candidate cluster.

17. The apparatus of claim 11, wherein the instructions, when executed by the one or more processors further cause the LiDAR-based object perception apparatus to generate a new tracking region for the at least one first cluster or update a tracking region of a previous time frame based on a correlation between a region of a current time frame of the at least one first cluster and the tracking region of the previous time frame.

18. The apparatus of claim 17, wherein the correlation is determined based on a predicted region in the current time frame which is predicted from the tracking region of the previous time frame.

19. The apparatus of claim 11, wherein outputting the information comprises assigning flags indicating small-traffic-equipment to objects belonging to the at least one first cluster.

20. The apparatus of claim 19, wherein the instructions, when executed by the one or more processors further cause the LiDAR-based object perception apparatus to determine and track a predetermined number of objects according to a predetermined priority order, wherein small objects having a time-frame-based age of a predetermined value or less are excluded from the tracking except for the objects to which the flags indicating the small-traffic-equipment are assigned.
